(19) United States
(12) Patent Application Publication
(10) Pub. No.: US 2010/0317231 A1
(43) Pub. Date: Dec. 16, 2010

(54) ANCHOR STRUCTURE FOR ELECTRONIC CARD CONNECTORS

(76) Inventors: Shih-Chia LAI, Taipei County (TW); Kuo-Chi Lee, Taipei County (TW)

Correspondence Address: Muncy, Geissler, Olds & Lowe, PLLC, 4000 Legato Road, Suite 310, FAIRFAX, VA, 22033, US

(21) Appl. No.: 12/860,631

(22) Filed: Aug. 20, 2010

Related U.S. Application Data
(62) Division of application No. 11/822,618, filed on Jul. 9, 2007.

(51) Int. Cl. H01R 13/60

(52) U.S. Cl. 439/625

(57) ABSTRACT

An anchor structure for electronic card connectors to provide flexible control of fitness includes a fastening element and a body which has a holding bore at two ends. The fastening element has an anchor member and an anchor seat. The anchor member and the anchor seat have respectively an extended portion formed at an outer diameter slightly greater than the fastening element. The anchor member has a first anchor portion. The anchor seat has a second anchor portion. The first and second anchor portions can be coupled together or disengaged with each other.

### CROSS REFERENCE TO RELATED APPLICATIONS

This application is a Divisional of co-pending application Ser. No. 11/822,618, filed on Jul. 9, 2007, and for which priority is claimed under 35 U.S.C. §120, the entire contents of which are hereby incorporated by reference.

### FIELD OF THE INVENTION

The present invention relates to an anchor structure for electronic card connectors and particularly to an anchor structure that can flexibly control fitness of electronic card connectors.

### BACKGROUND OF THE INVENTION

The progress of electronic information products advances rapidly these days. Demands of users on electronic products are higher. Utilization scope of the electronic products is expanded constantly. Function of electronic products such as computers, mobile phones, digital cameras and the like also increases. The auxiliary function also is enhanced. The peripheral electronic circuits and connection terminals become more complex and versatile. The connectors generally mean connection elements and their accessories used to transmit electronic signals and power supply. They are indispensable elements in the electronic information products. Their quality not only affects the reliability of electric current and signal transmission, also impacts operation quality of the entire electronic equipment.

A connector generally has an insulation body with fixed pins formed thereon to be inserted into holding orifices of a circuit board. The pins are round brass struts or plastic struts. Such a structure tends to create shaking of the insulation body. It is not steady or reliable, and not desirable for soldering the connector pins. Dislocation easily occurs to the insulation body under forces during insertion or unplugging of external elements. And the pins of the connector are prone to loosen off and signal transmission could be impacted.

FIG. 1 illustrates a connector adopted a conventional technique. It has a fastening member 3 formed in a round strut to be inserted into a holding orifice 2 at two ends of a body 1. The fastening member 3 has a riveting portion 4 exposed outside the upper edge of the holding orifice 2 to be riveted to form a tight coupling between the fastening member 3 and the body 1. Then the body 1 is coupled with an external element (not shown in the drawing). The external element and the fastening member 3 are fastened together by screwing (through a fastening element, also not shown in the drawing). However the conventional technique previously discussed still has drawbacks, notably:

1. It requires a riveting operation in the fabrication process. More production time is needed.

2. Riveting operation has to be performed under a huge force that easily damages the structure of the body. On the other hand, to do the riveting operation at a smaller force does not form a strong enough binding, and the body is easily loosened that could affect the quality of signal transmission.

3. Riveting operation forms a fixed coupling on the holding orifice. It cannot be disassembled and the fitness cannot be controlled.

### SUMMARY OF THE INVENTION

The primary object of the present invention is to solve the aforesaid disadvantages. The present invention provides a fastening element that does not need rivet coupling. Production time can be reduced. The fastening element has an anchor structure mating a body to form a secure coupling that is not too tight or too loose. And it can be flexibly controlled to achieve a desired fitness.

The anchor structure for electronic card connectors according to the invention includes an fastening element to be held in a holding orifice at two ends of a body. The fastening element has an anchor member and an anchor seat. The anchor member and the anchor seat have respectively an extended portion formed at a diameter slightly greater than the fastening element. The anchor member has a first anchor portion. The anchor seat has a second anchor portion corresponding to the first anchor portion. The first and second anchor portions can be coupled together or separated.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional anchor structure for connectors.

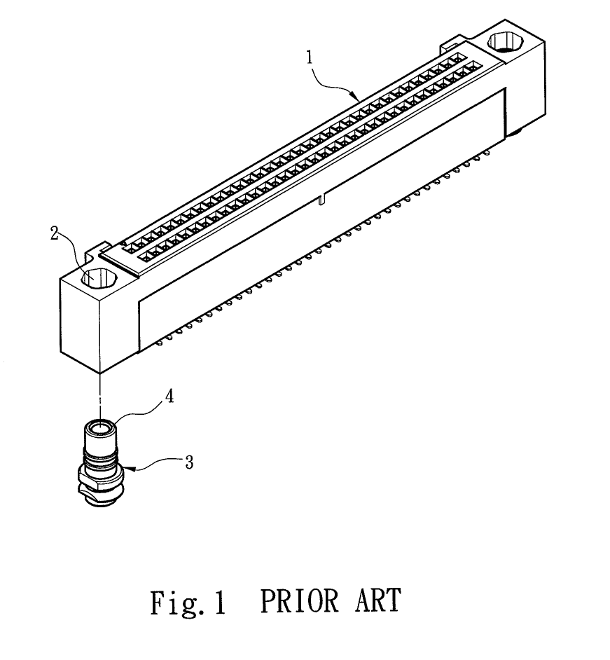

FIG. 2 is an exploded view of the anchor structure for electronic card connectors of the invention.

FIG. 3 is a schematic view of an embodiment of the anchor structure for electronic card connectors of the invention.

FIG. 4 is a sectional view of an embodiment of the anchor structure for electronic card connectors of the invention.

FIG. 5 is an exploded view of another embodiment of the anchor structure for electronic card connectors of the invention.

### DETAILED DESCRIPTION OF THE PREFERRED EMBODIMENTS

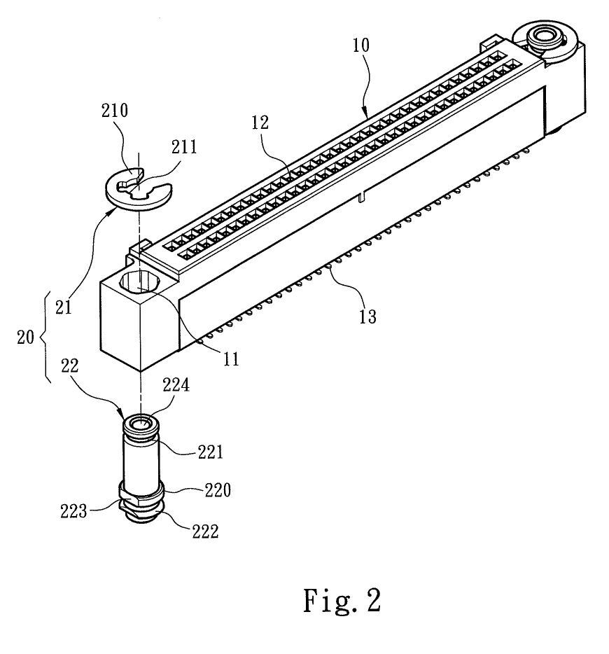

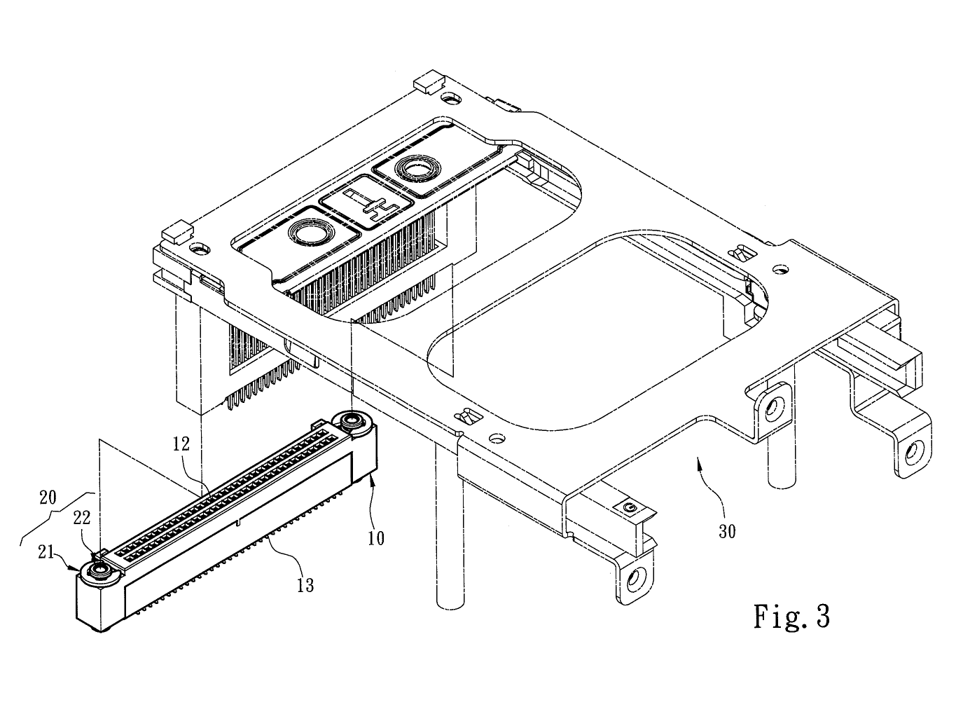

Please refer to FIGS. 2, 3 and 4, the anchor structure for electronic card connectors according to the invention includes a body 10 and a fastening element 20. The body 10 has a holding bore 11 to hold the fastening element 20. The fastening element 20 includes an anchor member 21 and an anchor seat 22. The anchor member 21 and anchor seat 22 have respectively an extended portion 210 and 220 that have an outer diameter greater than the fastening element 20. The anchor member 21 has a first anchor portion 211. The fastening seat 22 has a corresponding second anchor portion 221. In an embodiment of the invention the first and second anchor portions 211 and 221 are a C-shaped clip and a groove that mate each other so that they can be coupled or disengaged with each other.

In an embodiment of the invention, the anchor structure is coupled with a connector 30 and installed at a desired location on a circuit board 40. The connector 30 is inserted into an orifice 12 to be connected to a pin 13 in the orifice 12. The pin 13 is connected to the circuit board 40 so that the connector 30 is electrically connected to the circuit board 40 in a firm manner. The anchor seat 22 runs through the holding bore 11 of the body 10. The second anchor portion 221 is exposed outside the holding bore 11 and latched by the first anchor portion 211 of the anchor member 21. Thereby the anchor member 21 and the anchor seat 22 form a flexible coupling to control fitness of the body 10.

In addition, the anchor seat 22 has an expanded portion 222 formed at an outer diameter corresponding to the extended portion 220. The expanded portion 222 is annular with a sloped surface to allow the fastening element 20 to be soldered on the circuit board 40. The holding bore 11 further has an aperture 110 formed at a greater diameter to house the extended portion 220. The aperture 110 has a plane bucking surface 111. The extended portion 220 has a tangent surface 223 in parallel with the axis of the anchor seat 22. The bucking portion 111 and the tangent surface 223 form a confined relationship so that the fastening element 20 cannot rotate in the holding bore 11. Hence when a screwing element 31 of the connector 30 is screwed with a bucking hole 224 of the fastening element 20 the fastening element 20 does not rotate in an idle manner.

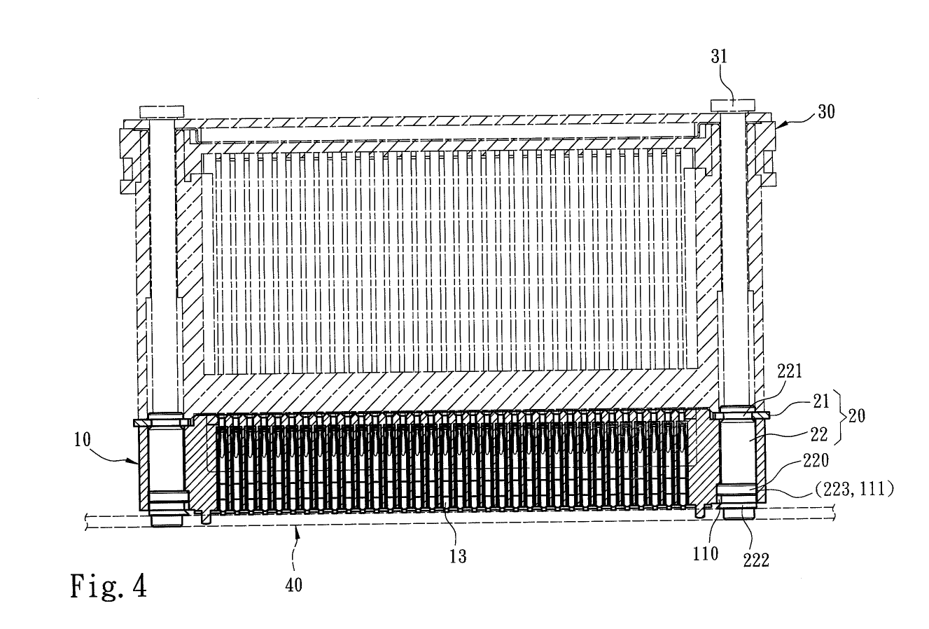

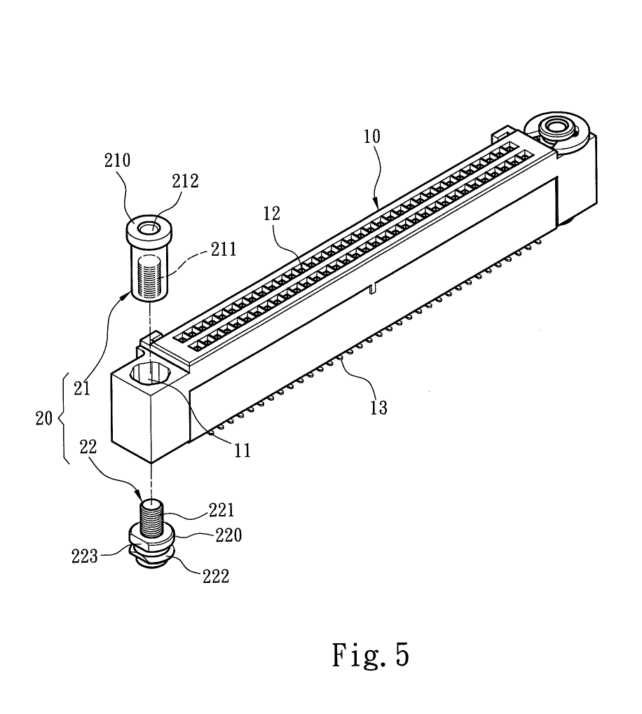

Refer to FIG. 5 for another embodiment of the anchor structure of the invention. It differs from the embodiment previously discussed by having screw threads on the first and second anchor portion 211 and 221 that mate each other so that they can be engaged by screwing to form a secure coupling between the fastening element 20 and the body 10. The anchor seat 22 also has the same extended portion 220 and expanded portion 222 of the former embodiment of the invention. And the extended portion 220 also has a tangent surface 223 in parallel with the axis of the fastening element 20. The anchor member 21 has an extended portion 210 with a bucking cavity 212 formed thereon to be engaged with a screwing element 31 of the connector 30 (also referring to FIG. 4) so that when the connector 30 is coupled with the body 10 the tangent surface 223 can prevent the fastening element 20 from rotating while the screwing element 31 is screwed in the bucking cavity 212.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An anchor structure for electronic card connectors, comprising:
a body having two ends which have respectively a holding bore formed thereon; and
a fastening element which runs through the holding bore and includes an anchor member having a bucking cavity formed at a top end thereof and an anchor seat that have respectively an extended portion formed at an outer diameter greater than the fastening element;
wherein the anchor member has a first anchor portion and the anchor seat has a second anchor portion, the first and second anchor portions respectively have a screw thread mating each other and are couplable and separable.

2. The anchor structure of claim 1, wherein the anchor seat has an expanded portion formed at an outer diameter mating the extended portion.

3. The anchor structure of claim 2, wherein the expanded portion is annular and has a sloped surface.

4. The anchor structure of claim 1, wherein the extended portion has a tangent surface in parallel with the axis of the anchor seat.

5. The anchor structure of claim 1, wherein the holding bore has an aperture of a greater diameter communicating with the holding bore.

6. The anchor structure of claim 5, wherein the aperture has a plane bucking portion.
